(19) United States
(12) Patent Application Publication
(10) Pub. No.: US 2011/0137694 A1
(43) Pub. Date: Jun. 9, 2011

(54) Planning Device and Method for Planning a Technical Installation

(76) Inventors: Michael Schlereth, Wilhermsdorf (DE); Thilo Stolper, Numberg (DE)

(21) Appl. No.: 12/529,068

(22) PCT Filed: Jan. 18, 2008
(86) PCT No.: PCT/EP2008/000383

§ 371 Date: Dec. 11, 2009

(51) Int. Cl. G06Q 10/00

(52) U.S. Cl. 705/7.12

(57) ABSTRACT

A planning device for planning a technical installation is provided. The technical installation is constituted of mechanical components and electrical components, every component having a component functionality. Component sets constituted of functionally different components are selected from a library, the component functionalities being shown in the library subdivided into different degrees of detail and a component set having a desired degree of detail being selectable from the library.

### CROSS REFERENCE TO RELATED APPLICATIONS

This application is the US National Stage of International Application No. PCT/EP2008/000383 filed Jan. 18, 2008, claims the benefit thereof and is incorporated by reference herein in its entirety.

### FIELD OF INVENTION

The invention relates to a planning device for planning a technical installation, especially a production installation, with the technical installation being formed from modules each of which features mechanical components and electrical components. The invention also relates to a corresponding method for planning a technical installation.

### BACKGROUND OF INVENTION

The article entitled “objektorientierte Fabrikplanung” (object-oriented factory planning) by G. Schuh, in the German periodical Werkstatttechnik Online, Volume 97 (2007), No. 3, describes a method for object-oriented factory planning. A comparison is made with software engineering. A hierarchical structure is proposed for the planning of a factory. Modules of the factory are designed in hierarchical consecutive planning stages from a coarse schematic representation through to a fine, more detailed representation. Each module is designed in this case, as in object-oriented programming, in accordance with the encapsulation principle, so that it can easily be exchanged if the planning is modified. Interactions are only possible via interfaces explicitly provided.

### SUMMARY OF INVENTION

Digital planning of technical installations is assuming ever greater importance. By virtual mapping of the technical installation investment can be safeguarded right at a very early stage by a simulation. With production installations product planning can be converted very much more quickly into a finished product. Such digital planning requires a very large volume of data. As well as the purely digital image of the technical installation through its geometry in the fowl of a 3D simulation, attempts are increasingly also being made to simulate the technical functionalities in the form of a virtual commissioning. As well as geometrical and mechanical properties of the components of the technical installation, this also includes more and more electrical properties. With a production installation, in addition to the geometrical properties, for example of a production robot and the dimensions of a production cell, properties of an electric motor for example, such as electrical output power or torque, are also being considered. As a rule all components are interacting with each other. In order to check the suitability of a component for the intended task, further components must already be selected in order to establish by means of a simulation whether the desired result is being achieved. The large diversity of possible combinations produced by this would lead to a large planning overhead in the determination of an optimum configuration.

An object of the invention is to specify a planning device with which a technical installation is able to be planned with especially low planning outlay. A further object of the invention is to specify a corresponding planning method.

Inventively the object directed to the planning device is achieved by specifying a planning device for planning a technical installation, with the technical installation being formed from mechanical components and electrical components, with each component having a component functionality and with sets of components formed from components being able to be selected from a library, characterized in that the component functionalities are mapped divided into different levels of detailing in the library and a set of components is able to be selected from the library with a desired level of detailing.

The invention uses as its starting point the idea that diverging from a strictly object-oriented planning view can lead to an increased planning efficiency. A strictly object-oriented view demands an encapsulation of the objects.

By contrast the invention allows planning which cuts across object boundaries. By representing the mechanical and electrical components in component sets it is possible, by selecting from the library, to transfer entire component sets covering several objects into current planning. By grouping the electrical components into a component set a marked simplification of the planning process is achieved. The components of a component set can be matched to each other so that planning relating to the interactions between the components of a component set will be simplified. A component set thus already has an internal compatibility. In this case the planning is iteratively refined by the planner being able to access the component sets at a different level of detailing. A component set is thus stored in the library at different levels of detailing.

Preferably the component functionalities are mapped at least partly by parameters. By preference the component functionalities are mapped at least partly by function automata so that a component function is able to be represented in conjunction with parameters. Preferably the component functionalities are mapped at least partly by mathematical functions, by means of which a transformation from first parameters to second parameters describing the component functionality is undertaken.

The component functionalities can thus be mapped in a different way in the library. In the simplest form they are mapped by parameters. With a further option a function automaton is defined which describes a specific function in an abstract manner. Furthermore it is possible to define a component functionality via a mathematical function by means of which parameters already present are transformed so that the new parameters arising describe the component functionalities.

By preference a component set of a higher level of detailing will be integrated after selection from the library in the current planning status into the same component set of a lower level of detailing already selected such that the functionalities of the lower level of detailing are supplemented by the functionalities of the higher level of detailing. The representation of the higher level of detailing is thus undertaken in this embodiment not by overwriting the functionalities already present in the lower level of detailing but by supplementing said functionalities.

Preferably the component sets are grouped into a collection. It can be useful to group together component sets according to a specific condition. The condition that the components to be used must be embodied directed towards safety might be conceivable. A further possible condition could be the use of components of a specific manufacturer. The fact that components sets are now grouped into a collection satisfying such conditions means that the planning process is further simplified, since the requirements can be met by simple selection of such a collection.

Preferably selectable functionalities of component sets can be switched invisibly for a user. Such invisible switching can for example bring about a further reduction of the complexity of the planning process. If specific functionalities are irrelevant in the current planning stage, these can be hidden from a planner, so that the latter can restrict himself or herself to the relevant functionalities in his or her planning. Such invisible switching can also be undertaken depending on the status or role of the user. If the user identifies himself or herself, during login for example, then on the basis of an assigned user profile the scope of the functions enabled for the user or also the levels of detailing can be defined. For example the experience of the user when dealing with the system can also be taken into consideration.

Preferably the technical installation is formed from modules with mechanical components and electrical components, with each module having a required functionality and in which case it is possible to check whether the module functionality produced for a module with a selected component set matches the required functionality within the framework of a predeterminable accuracy.

The functionality of a module is described by the required functionality. An entire component set is now used to implement this required functionality. A component set can be understood to a certain extent as a set of items of clothing. The putting on of this set of items of clothing to try them on corresponds to a comparison of the functionality produced from the component set with the required functionality. Preferably the component set is further developed over time so that matching its functionality with the required functionality of a largest possible number of modules is achieved.

Preferably the checking for a match is undertaken by a simulation of module functionalities, with the simulation being based on the component parameters. A digital planning of a technical installation can be completed by a simulation of the execution sequences on the technical installation. Such a simulation allows it to be established whether the components used actually deliver the desired functionality. For example the result of a real-time simulation could be that the components used do not lead to the process running at the desired speed. In this case the component set can thus not be used unchanged.

Preferably the check for a match is made by comparing the required parameters which characterize the required functionality with corresponding component parameters of the component set. The required functionality is thus mapped by parameters. A component set is described by parameters which at least in part correspond in their type to the parameters of the required functionality. If the parameters of the component set also correspond in their value to the parameters of the required functionality, for example if they lie within an appropriate interval, the desired match is made.

Preferably the electrical components are embodied mechatronically with additional mechanical functionality. To an increasing degree electrical and mechanical elements of a component are combined into an integrated structure. For example piezoelectric components can fulfill mechanical tasks. The integrated design of a gripper aim together with its electrical drive can also be a mechantronic component. The use of mechatronic components leads to a further simplification of the planning process.

Preferably the planning is able to be undertaken by a planning process divided up into hierarchy levels with consecutive planning stages, with the mechanical or electrical components of a subplanning stage of the at least second hierarchy level having the mechanical or electrical components of the upper planning level from the hierarchy level below the lower planning level and in addition having a higher level of detail in respect of the properties of the mechanical or electrical components. It is also preferable for the planning device to have an object-oriented architecture so that, as defined by the rules of object-oriented planning a planning stage is described by classes which instantiate objects with properties of the mechanical and electrical components as attributes and methods of the module functionalities, with a subplanning level inheriting methods of the upper planning level.

A planning process divided into hierarchy levels enables a higher level of detail to be set step-by-step in consecutive planning levels. An inheritance of properties enables planning of a previous planning stage to be firmed up in a simple manner. The fact that detailing is now available by selecting a component set from a library enables the planning of a planning stage to be undertaken in an especially efficient manner with a high level of detail. A component set in this case is available as a set of classes as defined by object-oriented programming.

Preferably the planning device has a visualization device in which the modules are able to be mapped graphically, with the level of detailing of the graphical representation growing increasing hierarchically through the planning stages and with the subplanning stage being represented by an overlaying of graphical elements from this subplanning stage over the elements of its upper planning stage. The planning of a technical installation requires a visualization which is generally undertaken by a 2D or 3D representation on the computer. Increased detailing of a planning level is now usefully achieved by overlaying its elements over the abstract elements of the previous planning stage. The use of entire component sets becomes clear in this visualization in that a specific collection is drawn like an envelope over the more abstract representation. A deviation from the functionality produced by the selected collection, i.e. of the component sets, can be made visible by graphical means. For example components of the component set which cause the deviation from the required function can be shown flashing or in another color.

Preferably the technical installation is a production installation for producing a product. The digital planning of a factory for producing a product is already reality in many areas. The planning of such a production installation is extremely complex. The selection of electrical components, especially of automation components, is generally subject to the general conditions of the installation creator or operator. In particular a manufacturer-specific selection is often to be taken into account.

The object oriented to a method is inventively achieved by specifying a method for planning a technical installation, with the technical installation being formed from mechanical and electrical components, with each component having a component functionality and with sets of components formed from components being selected from a library, with the component functionalities being mapped in the library divided up into different levels of detailing and a set of components with a desired level of detailing being selected from the library.

The advantages of such a method emerge from the information given above about the advantages of the planning device. Preferably the testing for a match is undertaken by comparing required parameters which characterize the required functionality with the component parameters.

Preferably the check for a match is performed by a simulation of the module functionality, with the simulation being based on the parameters of the component set.

### BRIEF DESCRIPTION OF THE DRAWINGS

The invention will be explained in greater detail with reference to figures. Some of the figures are schematic and not to scale and show

FIG. 1 a technical installation,

FIG. 2 a module of a technical installation,

FIG. 3-5 a planning device and a set of components,

FIG. 6 a function automaton,

FIG. 7 a collection of sets of components,

FIG. 8 a visualization device for graphical representation of the planning and

FIG. 9, 10 diagrams of the visualization device of modules with different sets of components.

### DETAILED DESCRIPTION OF INVENTION

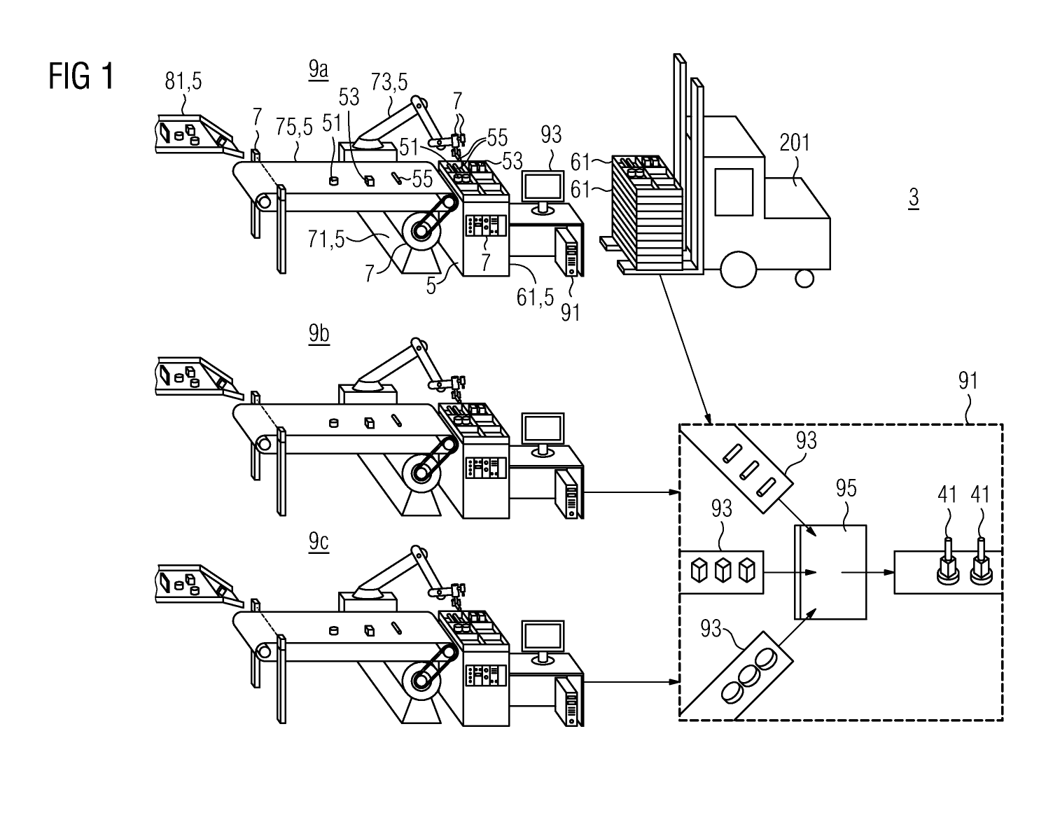

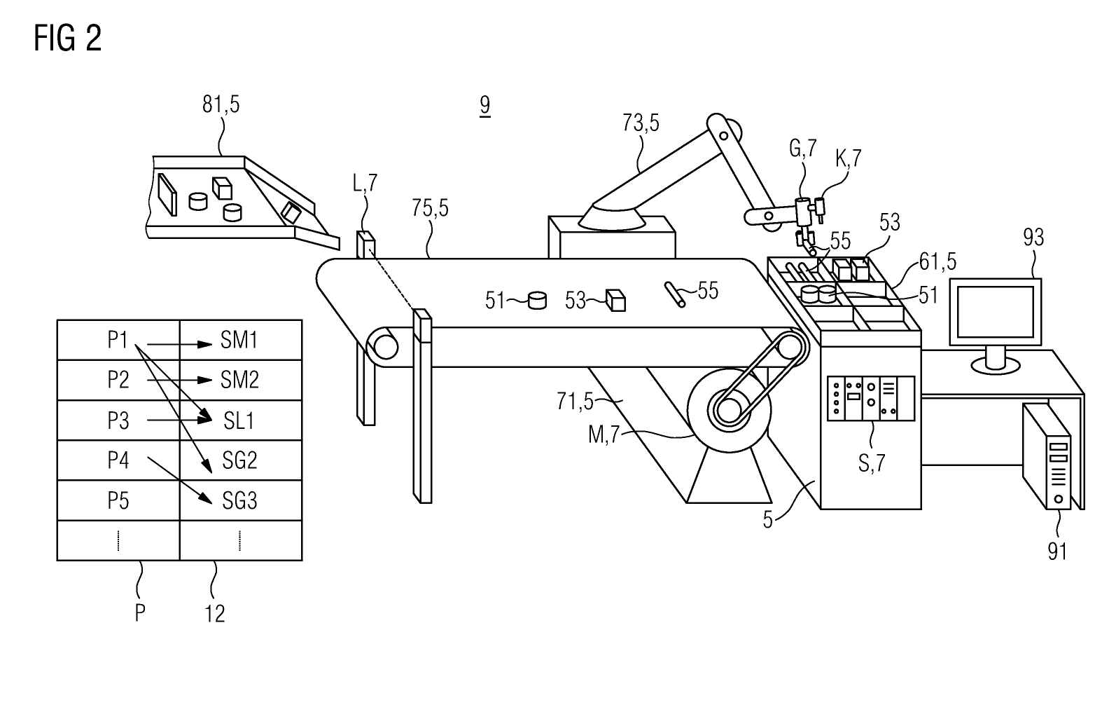

FIG. 1 shows a technical installation 3. The technical installation has three modules 9a, 9b, 9c. The modules 9 will be explained in greater detail in FIG. 2. The technical installation 3 is embodied here as a production installation. The modules 9 sort production parts. The production parts are transported on pallets 61 using fork-lift truck 201 to a further production section 91. There they are assembled by means of transport belts 93 in an assembly unit 95 into a product 41. The planning of a technical installation 3 demands a very accurate description of all components used in respect of their properties and functions. With more complex technical installations this rapidly leads to a very expensive planning process. It is explained below how this planning process can be designed more simply.

FIG. 2 shows one of the modules 9 of the technical installation 3 from FIG. 1. The module features a robot 73 with a gripper G. A camera K is installed on the gripper G for detecting samples. The robot 73 is installed in front of a conveyor 75. The conveyor 75 has a motor M for its drive which is placed on a pedestal 71. The robot 73, the conveyor 75 and the pedestal 71 are mechanical components 5 of the module 9. The gripper G, the camera K and the motor M are electrical components 7 of the module 9. The gripper G is embodied in this case as mechatronic component. As well as electrical components for driving it, it also features mechanical components for gripping. A further electrical component is a programmable logic control S. This control S is used for scheduling the production sequence on the module 9. By means of a computer 91 and a screen 93 it is possible to intervene in the execution and set parameters for it. Via a feed track, product parts 51, 53, 55 of different geometry are transported via the conveyor 75 to the robot 73. In doing so they pass a proximity sensor L embodied as a light barrier. The robot 73 uses the camera K to detect the different geometries of the product parts 51, 53, 55. Depending on geometry the robot 73 uses the gripper G to sort the product parts 51, 53, 55 into a pallet.

The required functionality of the module 9 is described in parameters. For example a parameter P1 specifies a required throughput. This leads to a requirement in respect of a set of required parameters 11 for the electrical components 7, e.g. for a parameter SM1 of the motor M but also in respect of a parameter SL1 for a resolution of the light barrier L or of a parameter SG2 for a grip speed of the gripper G. Thus other parameters F also determine the required functionality of the module 9 parameters of the electrical component 7.

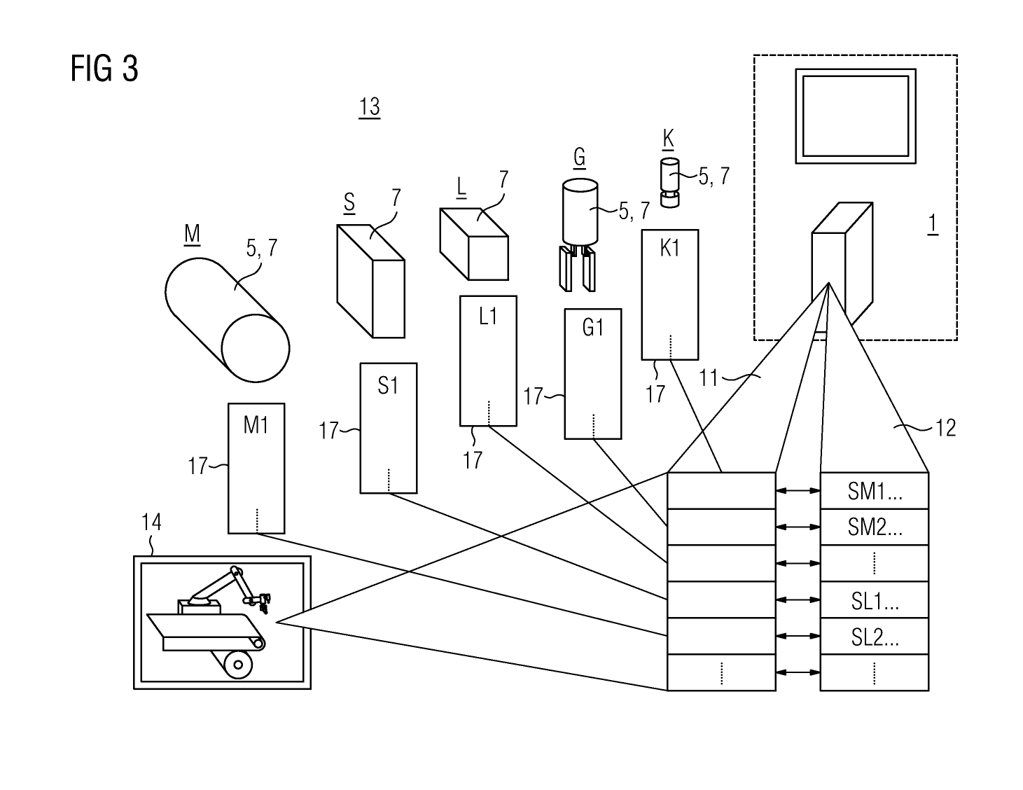

FIG. 3 depicts a set of components 13. The set of components 13 features a motor M, a control S, a light barrier L, a gripper G and a camera K. Each of these electrical components has a set of component parameters 17. The set of component parameters 13 is stored together with further sets of component parameters in a library 11 of a planning device 1. The planning device 1 also has the required parameters 12 available to it which, as described above, describe the required functionality of the module 9. By comparing the component parameters 17 of the set of components 13 with the required parameters a check is made as to whether the required functionality of the module 9 can be implemented by the component set 13. A further option for this check is provided by a simulation of the production run on the module 9. To this end the production run of the module 9 is simulated by a simulation device 14, as would be implemented with the component set 13 used. If the simulation results in a satisfactory production sequence, the checking is successful.

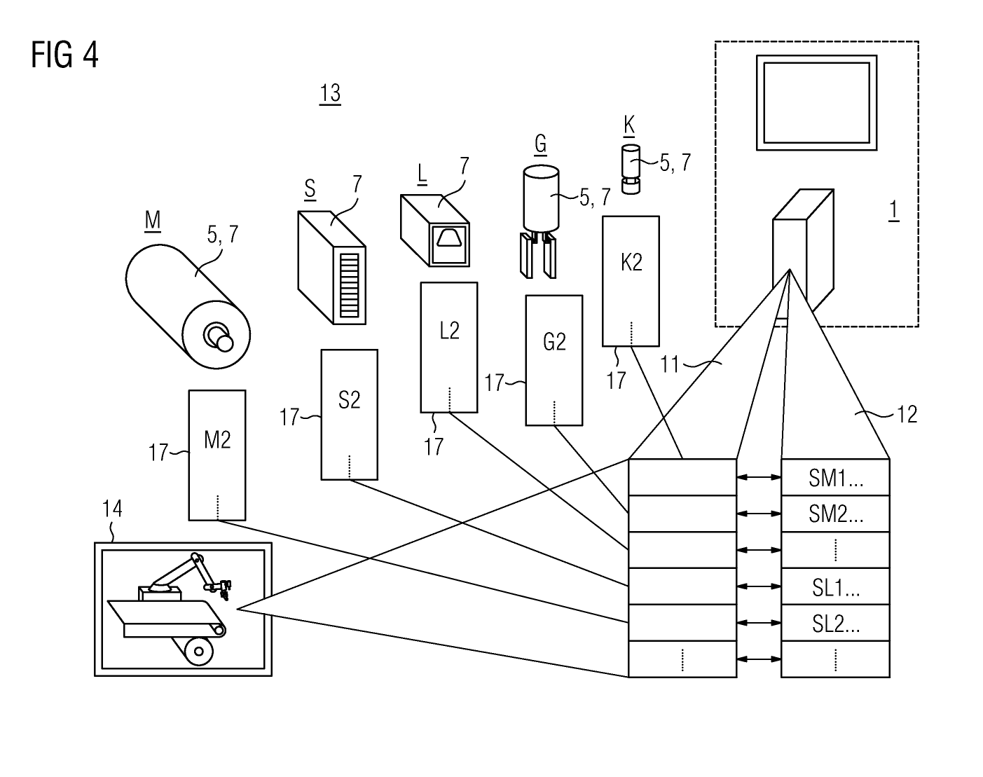

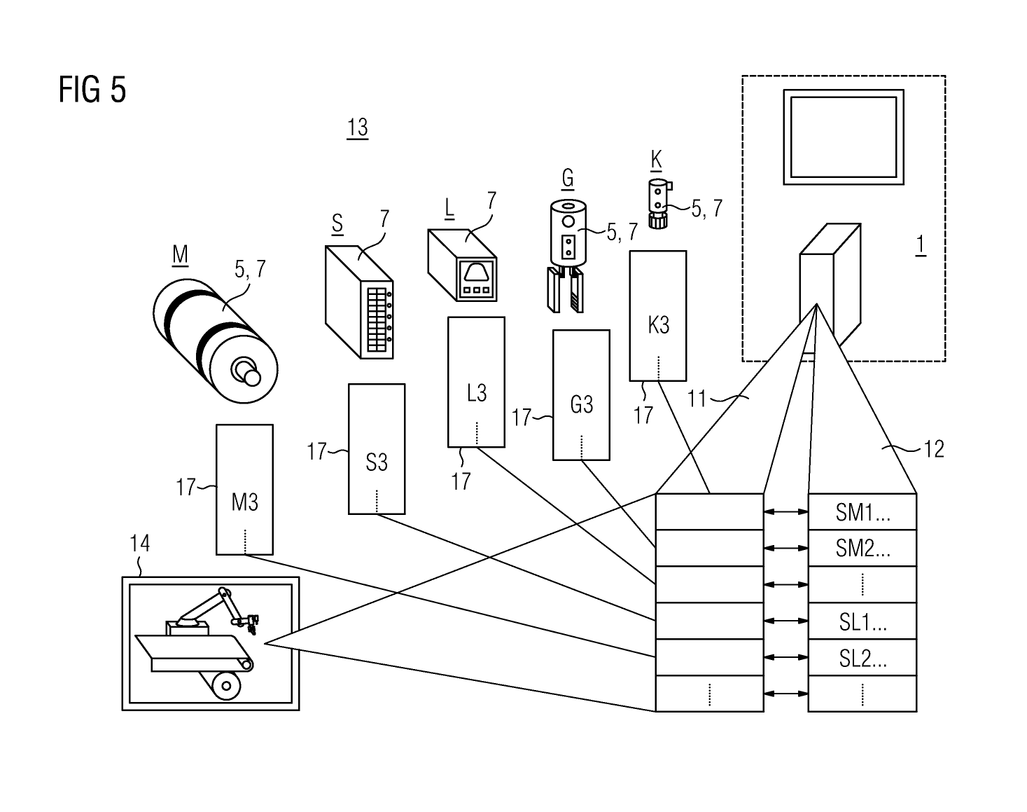

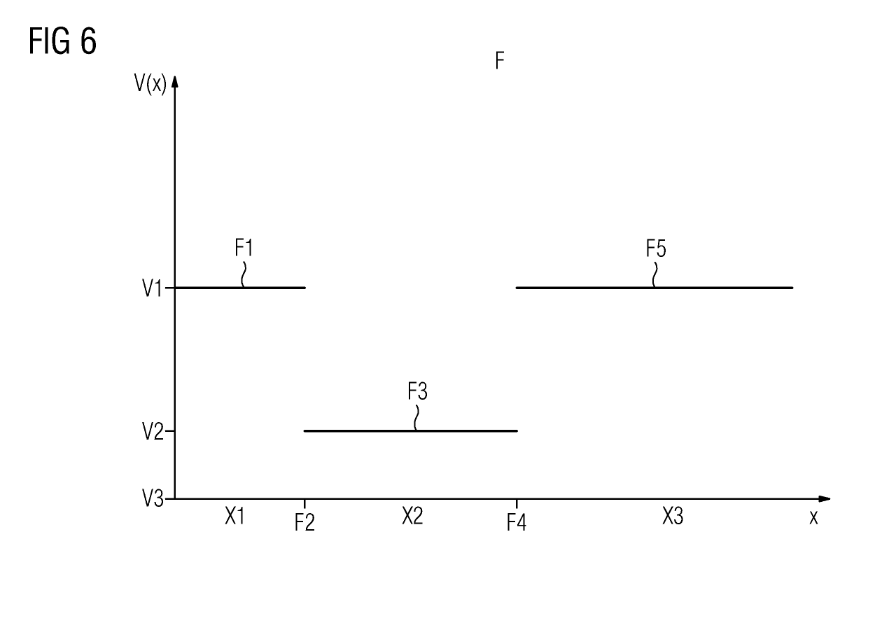

FIG. 4 shows the component set 13 from FIG. 3, with other component parameters 17 for supplementing the component parameters 17 from FIG. 3 being stored in the library so that a higher level of detailing is produced, i.e. additional functionalities of the components 5, 7 of the component set 13. A further higher level of detailing is then produced with the component set from FIG. 5. Thus it is possible to refine the planning iteratively. Unlike the method realized previously using an object-oriented approach with inheritance mechanisms, a pan-object equipping of the planning can be undertaken with the component set-oriented approach. The use of component sets with a selectable level of detail can be explained in visual terms as an enveloping process. Envelopes of component sets are placed over the representation of a schematic installation concept with each higher level of detailing. With the checking described above, although the required functionality is obtained, this coverage can be compared with a sample as to whether the selected components actually fit. In the planning process the different level of detailing can be made visible by suitable graphical representations, such as different colors or such like. A corresponding visualization system is described below. It should be stressed that different envelopes can be designed independently of each other so that an envelope can be removed without disturbing the planning state or can be replaced by another envelope.

As well the component functionality being represented by means of parameters, this functionality can also be represented by a function automaton. This will be explained by way of an example in FIG. 5. For transport along a route, e.g. with a conveyor belt, identified by the variable x, the transport speed V(x) is shown. The function automaton F specifies the states F1-F5 depending on the location x, i.e. transport is first undertaken with a speed V1 along a section X1, then a stop with V3=0, then a further transport with speed V2 along a section x2, then another stop with V3=0, then a further transport again at speed V1.

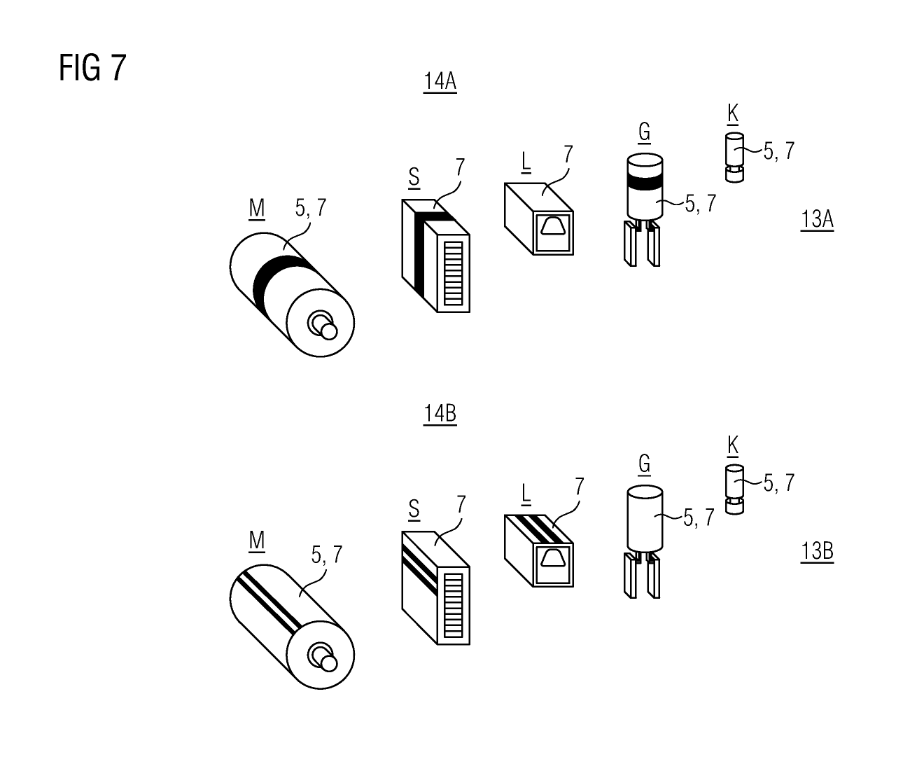

In planning the technical system requirements are frequently to be taken into account, e.g. the use of safety-oriented components or the use of components from a specific manufacturer. FIG. 7 shows a collection 14a which takes account of the use of safety-oriented components. The safety-oriented embodiment of a component is made visible in this example as a stripe on the housing. A component set 13A of this collection 14A where possible contains components which are safety versions. In a collection 14B account is taken of the fact that devices from a specific manufacturer are preferably to be employed. This is made visible in the figure by two stripes on the component housing. A component set 13B of this collection 14B is thus optimized to the extent that especially components of the predetermined manufacturer are used.

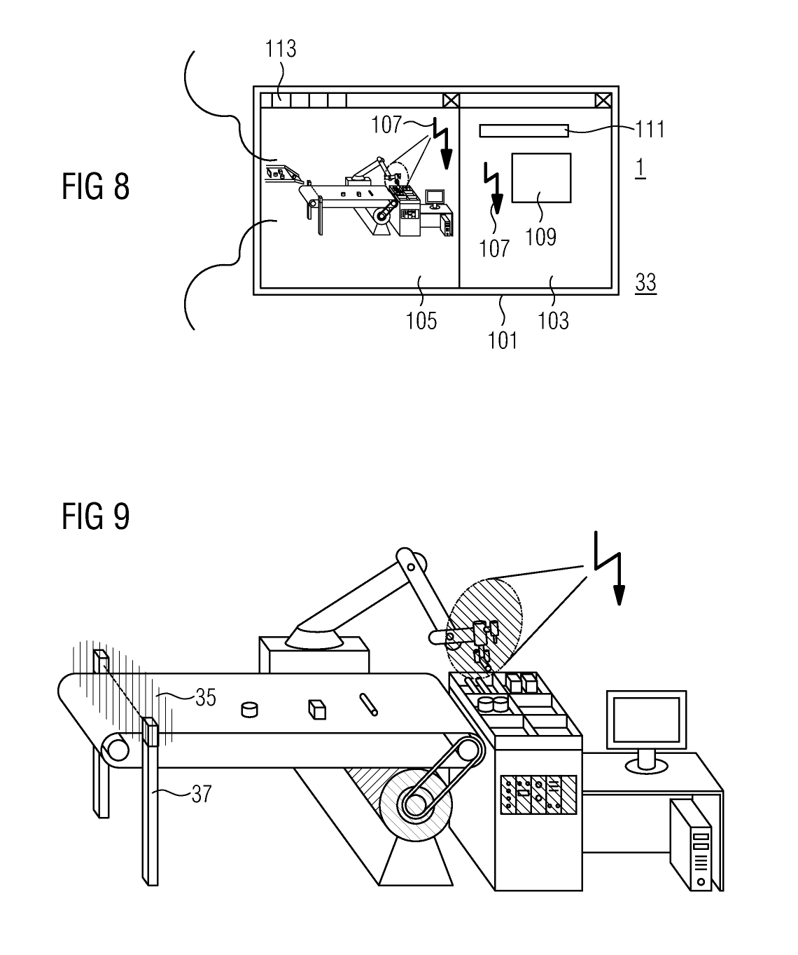

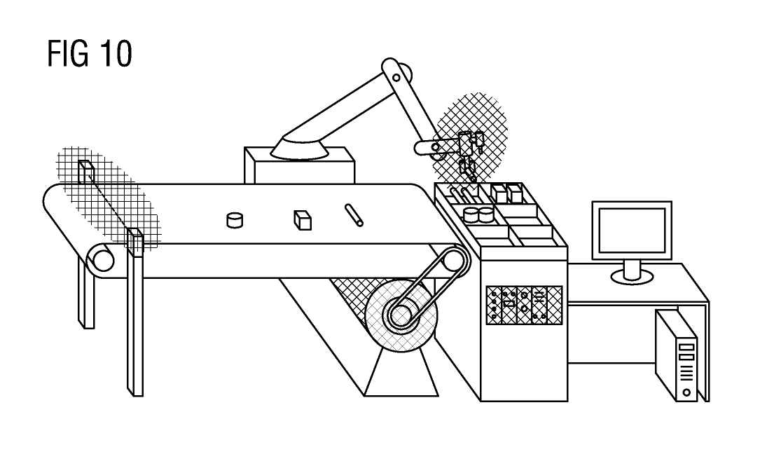

FIG. 8 is a visualization device 33 of a planning device 1. A first window 103 and a second window 105 are shown at a graphical user interface 101. In the second window 105 the technical installation 3 is mapped graphically. In the first window 103 a specific component set for a module of the technical installation is selected by means of an input dialog 111. By means of a menu 113 a simulation of the production process of the technical installation with the selected component set is undertaken. If a divergence in the simulated functionality from the predetermined required functionality is established, an error message 107 is issued. In the first window 103 an error description 109 for the error message 107 is output. FIG. 9 shows how a first component set is made known by a diagonal line shaded area, differentiated from the cross-hatched shaded area of a another component set in FIG. 10. While a required functionality is achieved with the component set from FIG. 10, the component set in FIG. 9 produces an error message.

1.-15. (canceled)

16. A planning device for planning a technical installation, the technical installation including mechanical components and electrical components, each component having a component functionality, comprising:
a library including component sets formed from functionally-different components, the component sets being selectable from the library,
wherein the component functionalities are mapped in the library divided into different degrees of detailing, and
wherein component sets are selected from the library with a desired degree of detailing.

17. The planning device as claimed in claim 16, wherein the component functionalities are mapped partly by first parameters.

18. The planning device as claimed in claim 17, wherein the component functionalities are mapped partly by function automata such that a function is represented in conjunction with the first parameters.

19. The planning device as claimed in claim 17, wherein the component functionalities are mapped partly by mathematical functions in order to transform the first parameters into second parameters describing the component functionality.

20. The planning device as claimed in claim 18, wherein the component functionalities are mapped partly by mathematical functions in order to transform the first parameters into second parameters describing the component functionality.

21. The planning device as claimed in claim 16, wherein a component set of a higher level of detailing is integrated into an already selected component set of a lower level of detailing after selection from the library into the actual planning status such that the functionalities of the lower level of detailing are supplemented by the functionalities of the higher level of detailing.

22. The planning device as claimed in claim 16, wherein component sets are grouped within a collection.

23. The planning device as claimed in claim 16, wherein the selectable functionalities of component sets are switched to be invisible to a user.

24. The planning device as claimed in claim 16, wherein the technical installation includes modules with mechanical components and electrical components, each module including a required functionality.

25. The planning device as claimed in claim 24, wherein it is checked whether a module functionality produced for a module selected with a component set matches the required functionality within a predetermined accuracy.

26. The planning device as claimed in claim 25, wherein the checking for a match is done by comparing required parameters characterizing the required functionality with corresponding component parameters of the component set.

27. The planning device as claimed in claim 25, wherein the checking for a match is done by a simulation of the module functionality, the simulation being based on the component parameters.

28. The planning device as claimed in claim 24, wherein the electrical components are mechatronic components with additional mechanical functionality.

29. The planning device as claimed in claim 25, wherein the electrical components are mechatronic components with additional mechanical functionality.

30. The planning device as claimed in claim 26, wherein the electrical components are mechatronic components with additional mechanical functionality.

31. The planning device as claimed in claim 27, wherein the electrical components are mechatronic components with additional mechanical functionality.

32. The planning device as claimed in claim 24, further comprising:
a visualization device configured to graphically map the modules,
wherein a level of detailing of a graphical representation along planning levels growing in ascending hierarchical order and with a representation of a lower planning level is done by an overlaying of graphical elements from the lower planning level over the elements of an upper planning level such that a more schematic representation of the upper planning level is enriched by the higher level of detail of the lower planning level.

33. The planning device as claimed in claim 16, wherein the technical installation is a production installation for producing a product.

34. A method for planning a technical installation, the technical installation including mechanical components and electrical components, comprising:
providing mechanical components and electrical components, each component including a component functionality;
providing a library including component sets formed from the mechanical and electrical components; and
selecting component sets from the library,
wherein the component functionalities are mapped in the library divided into different degrees of detailing, and
wherein a component set is selected from the library with a desired degree of detailing.

35. The method as claimed in claim 34, wherein a component set of a higher level of detailing is integrated into an already selected component set of a lower level of detailing after selection from the library such that the functionalities of the lower level of detailing are supplemented by the functionalities of the higher level of detailing.
